(19) United States
(12) Patent Application Publication
(10) Pub. No.: US 2009/0258266 A1
(43) Pub. Date: Oct. 15, 2009

(54) FUEL CARTRIDGE AND FUEL CELL GENERATION SYSTEM HAVING THE SAME

(75) Inventors: Jae-Hyuk Jang, Seoul (KR); Hye-Yeon Cha, Yongin-si (KR); Sung-Han Kim, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/265,327

(22) Filed: Nov. 5, 2008

(30) Foreign Application Priority Data
Apr. 14, 2008 (KR) 10-2008-0034182

(51) Int. Cl. H01M 8/18

(52) U.S. Cl. 429/21

(57) ABSTRACT

A fuel cartridge and a fuel cell power generation system equipped with the fuel cartridge are disclosed. The fuel cartridge can include a hydrogen generation part, which generates hydrogen by reacting with an electrolyte solution, a liquid-gas separation membrane, which surrounds the hydrogen generation part and separates the generated hydrogen from the electrolyte solution and discharges the hydrogen to the outside, and a cap, which opens and closes the liquid-gas separation membrane. The fuel cartridge of the present invention can reduce an effect of electrolyte solution flowing backwards and generate hydrogen more efficiently by minimizing the loss of electrolyte solution.

### CROSS-REFERENCE TO RELATED APPLICATIONS

This application claims the benefit of Korean Patent Application No. 10-2008-0034182 filed with the Korean Intellectual Property Office on Apr. 14, 2008, the disclosure of which is incorporated herein by reference in its entirety.

### BACKGROUND

1. Technical Field

The present invention relates to a fuel cartridge and a fuel cell power generation system equipped with the fuel cartridge.

2. Description of the Related Art

A fuel cell is an apparatus that converts the chemical energy of fuel (hydrogen, LNG, LPQ, etc.) and air directly into electricity and heat, by means of electrochemical reactions. In contrast to conventional power generation technologies, which employ the processes of burning fuel, generating vapor, driving turbines, and driving power generators, the utilization of fuel cells does not entail combustion processes. As such, the fuel cell is a relatively new technology for generating power that offers high efficiency and few environmental problems.

Examples of fuel cells being researched for application to portable electronic devices include the polymer electrolyte membrane fuel cell (PEMFC), which uses hydrogen as fuel, and the direct liquid fuel cell, such as the direct methanol fuel cell (DMFC), which uses liquid fuel directly. The PEMFC provides a high output density, but requires a separate apparatus for supplying hydrogen. Using a hydrogen storage tank for supplying hydrogen can result in a large volume and can require special care in handling and maintenance.

Methods used in generating hydrogen for a polymer electrolyte membrane fuel cell (PEMFC) can mainly include a method of utilizing the oxidation of aluminum, a method of utilizing the hydrolysis of metal borohydrides, and a method of utilizing reactions on metal electrodes. Among these, the method of using metal electrodes efficiently regulates the rate of hydrogen generation This is a method in which the electrons obtained when magnesium in the electrode is ionized to Mg²⁺ ions are moved through a wire and connected to another metal object, where hydrogen is generated by the dissociation of water. The amount of hydrogen generated can be regulated, as it is related to the distance between electrodes and the size of the electrodes.

However, in the conventional method of generating hydrogen according to the related art, generating hydrogen has had a problem of the electrolyte solution flowing backwards to the fuel cell stack. Moreover, when hydrogen generation comes to a halt due to the consumption of the electrolyte solution, hydrogen has to be refueled into the fuel cells.

As such, there is a need for a fuel cartridge, which replaces a worn-out cartridge when hydrogen generation comes to a halt, and a fuel cell power generation system equipped with the fuel cartridge.

### SUMMARY

An aspect of the invention provides a fuel cartridge that reduces an effect of electrolyte solution flowing backwards and generates hydrogen more efficiently.

In addition, the invention provides a fuel cell power generation system that increases the efficiency of electrical energy generation and generates electrical energy more efficiently.

Another aspect of the invention provides a fuel cartridge. The fuel cartridge can include a hydrogen generation part configured to generate hydrogen by reacting with an electrolyte solution, a liquid-gas separation membrane, which wraps the hydrogen generation part, configured to dissociate the generated hydrogen from the electrolyte solution and discharge the hydrogen to the outside, and a fuel cartridge, which comprises a cap configured to open and close the liquid-gas separation membrane.

Certain embodiments of the invention may include one or more of the following features.

The liquid-gas separation membrane can be comprised of flexible materials.

The liquid-gas separation membrane can be comprised of a material comprising hydrophobic substances having multiple air-holes formed therein.

The liquid-gas separation membrane can be comprised of a material comprising a poly tetra fluoro ethylene (PTFE).

The hydrogen generation part can include an anode generating electrons and the cathode generating hydrogen by receiving the electrons from the anode.

The connection-terminal connecting the anode and the cathode electrically to outside can be formed on the cap. Yet, another aspect of the invention provides a fuel cell generation system, The fuel cell generation system can include a housing, a membrane electrode assembly coupled to the housing and configured to generate electrical energy by converting the chemical energy of hydrogen, a cover coupled to the housing to seal the inside, and a fuel cartridge configured to supply hydrogen to the membrane electrode assembly and positioned inside the housing, in which the fuel cartridge comprises a hydrogen generation part configured to generate hydrogen by reacting with an electrolyte solution, an liquid-gas separation membrane for wraping the hydrogen generation part, the liquid-gas separation membrane configured to separate the generated hydrogen from the electrolyte solution and discharge the hydrogen to the outside, and a fuel cartridge comprising a cap configured to open and close the liquid-gas separation membrane.

Certain embodiments of the invention may include one or more of the following features.

The liquid-gas separation membrane can be comprised of flexible materials.

The liquid-gas separation membrane can be comprised of a material comprising hydrophobic substances having multiple air-holes formed therein.

The liquid-gas separation membrane can be comprised of a material comprising a poly tetra fluoro ethylene (PTFE).

The hydrogen generation part can include an anode generating electrons and the cathode generating hydrogen by receiving the electrons from the anode.

The connection-terminal connecting the anode and the cathode electrically to outside can be formed on the cap. The control circuit, which is configured to control electrical conduction of the anode and the cathode by connecting electrically with the connection-terminal, can be formed on the cover.

The apertures can be formed on the housing such that the membrane electrode assembly can be exposed to outside air.

The channels, which are configured to move the hydrogen from the fuel cartridge to the membrane electrode assembly, can be formed on the housing.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram illustrating how a fuel cartridge generates hydrogen in accordance with an embodiment of the present invention.

FIG. 2 is a perspective view illustrating a fuel cartridge in accordance with an embodiment of the present invention.

FIG. 3 is a perspective view illustrating a fuel cell power generation system in accordance with another embodiment of the present invention.

FIGS. 4 and 5 are perspective views illustrating a mobile phone to which a fuel cell power generation system is applied in accordance with another embodiment of the present invention.

### DETAILED DESCRIPTION

A fuel cartridge and a fuel cell power generation system equipped with the fuel cartridge according to certain embodiments of the present invention will be described below in more detail with reference to the accompanying drawings. Those components that are the same or are in correspondence are rendered the same reference numeral regardless of the figure number, and redundant explanations are omitted.

It is to be noted that coupling of components encompasses not only the direct physical engaging between the components but also the engaging of the components with another element interposed in-between such that the components are in contact with the other element.

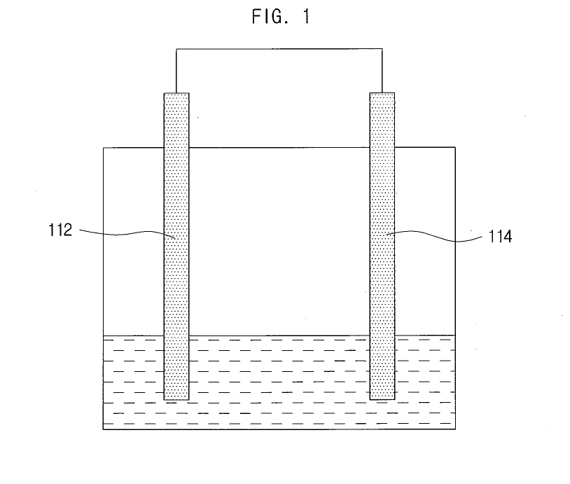

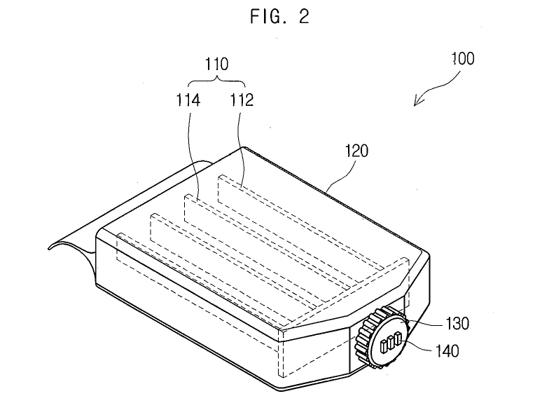

FIG. 1 is a diagram illustrating how a fuel cartridge generates hydrogen in accordance with an embodiment of the present invention, and FIG. 2 is a perspective view illustrating a fuel cartridge in accordance with an embodiment of the present invention.

Illustrated in FIGS. 1 and 2 are a fuel cartridge 100, a hydrogen generation part 110, an anode 112, a cathode 114, a liquid-gas separation membrane 120, a cap 130, and a connection terminal 140.

The present embodiment provides a fuel cartridge 100 that can reduce the reverse flow of an electrolyte solution during the generation of hydrogen and increase the efficiency of hydrogen generation by minimizing the loss of the electrolyte solution.

The hydrogen generation part 110 can generate hydrogen by reacting with the electrolyte solution. The hydrogen generation part 110 can include the anode 112, generating electrons, and the cathode 114, generating hydrogen by receiving the electrons from the anode 112, both of which are placed inside the electrolyte solution. Below, reactions occurred from the anode 112 and the cathode 114 will be described with reference to FIG. 1.

The anode 112 is an active electrode, which can generate electrons inside the electrolyte solution. The anode 112 can be made of magnesium (Mg), for example, and due to the difference in ionization tendency between the anode 112 and hydrogen, the anode 112 can release electrons into water and be oxidized into magnesium ions (Mg²⁺).

The electrons generated thus can travel to the cathode 114 that is electrically connected with the anode 112. Therefore, the anode 112 gets dissipated while generating electrons. Also, as it will be described later, the anode 112 can be made of a metal having a greater tendency of ionizing than the material used for the cathode 114.

The cathode 114 is an inactive electrode, which is not expended, unlike the anode 112, and thus can be implemented with a lower thickness than the anode 112. The cathode 114 can be positioned inside the electrolyte solution and receive the electrons generated at the anode 110 to generate hydrogen.

The cathode 114 can be made of stainless steel, for example, and can react with the electrons to generate hydrogen. That is, the chemical reaction at the cathode 114 involves water being dissociated, after receiving the electrons from the anode 112, to form hydrogen at the cathode 114. The reactions at the anode 112 and the cathode 114 can be represented by the following Reaction Scheme 1.

[Reaction Scheme 1]

| | |
|---|---|
| Anode 112: | Mg → Mg²⁺ + 2e⁻ |
| Cathode 114: | 2H₂O + 2e⁻ → H₂ + 2(OH)⁻ |
| Overall Reaction: | Mg + 2H₂O → Mg(OH)₂ + H₂ |

A compound such as LiCl, KCl, NaCl, KNO₃, NaNO₃, CaCl₂, MgCl₂, K₂SO₄, Na₂SO₄, MgSO₄, AgCl, or a combination thereof can be used in the electrolyte solution, and the electrolyte solution can contain hydrogen ions.

While this embodiment presents an example of the hydrogen generation part 110 consisting of the anode 112 and the cathode 114, it is apparent that the hydrogen generation part 110 of the present invention can include generating hydrogen by, for example, using a reaction between a metal, such as aluminum, and water.

The liquid-gas separation membrane 120, which surrounds the hydrogen generation part 110, can separate hydrogen generated at the hydrogen generation part 110 from the electrolyte solution and discharge the hydrogen to the outside. The liquid-gas separation membrane 120 can be comprised of a material comprising a hydrophobic substance, i.e. poly tetra fluoro ethylene (PTFE), which has multiple air holes formed therein. Since the liquid-gas separation membrane 120 surrounds the hydrogen generation part 110, the hydrogen generated can be dissociated from the electrolyte solution and discharged to the outside through the surfaces of the liquid-gas separation membrane, which prevents the electrolyte solution from permeating through it.

The liquid-gas separation membrane 120 can be comprised of a flexible material, and thus the membrane can be compact and highly portable before the electrolyte solution is injected to the inside.

Since there can be a supplement to improve reactions at the anode 112, the cathode 114 and the electrolyte solution, if pure water is injected into the liquid-gas separation membrane 120 by the user, the pure water can become an electrolyte solution that is reactive with the anode 112 and the cathode 114. The cap 130 can open and close the liquid-gas separation membrane 120 in order for the electrolyte solution to be injected. That is, by opening and closing the liquid-gas separation membrane 120, the cap 130 can seal the housing after the empty liquid-gas separation membrane 120 is injected with the electrolyte solution for generating hydrogen.

Here, the connection terminal 140 can be formed on the cap 130 to connect the anode 112 and the cathode 114 electrically to the outside, and an outside device can control electrical conduction of the anode 112 and the cathode 114, which are electrically connected to the connection terminal 140, thereby controlling the time consumed for generating hydrogen and an amount of hydrogen produced. Here, the outside device can be a part of the fuel cell generation system, which will be described in an embodiment of the fuel cell generation system below.

Next, an embodiment of a fuel cell generation system according to another aspect of the present invention will be described.

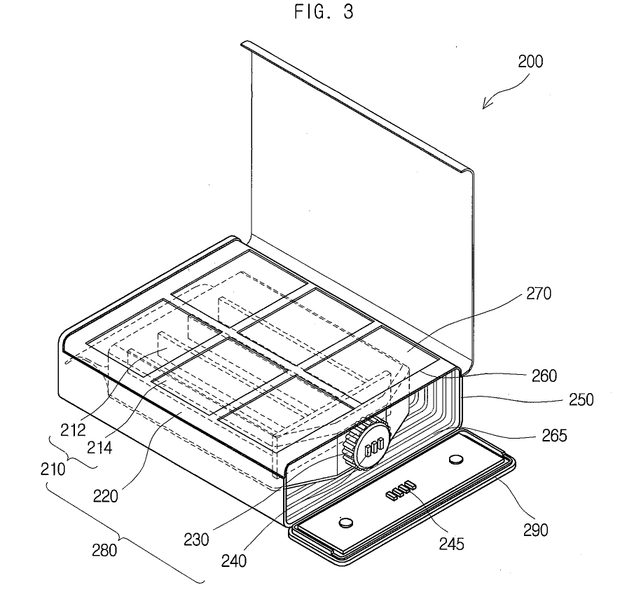

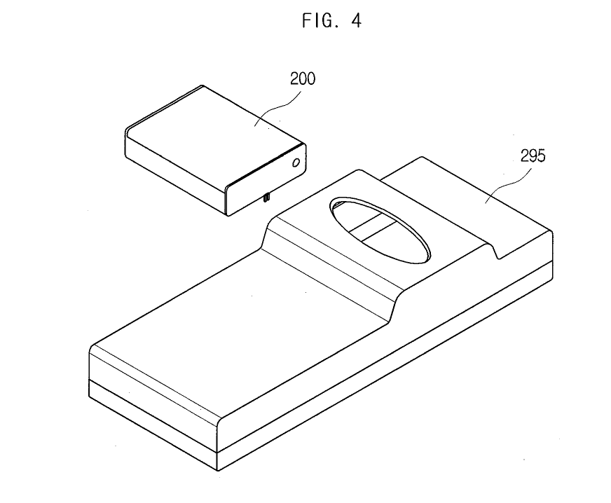

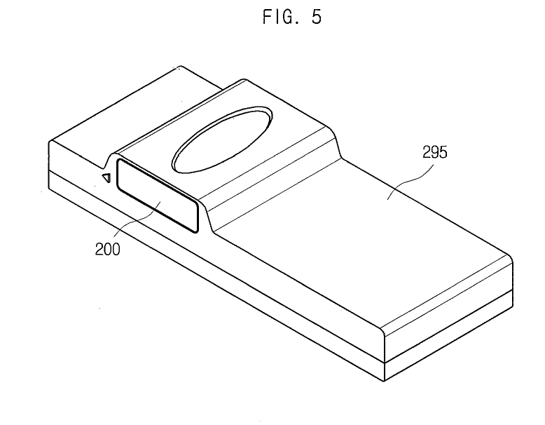

FIG. 3 is a perspective view illustrating an embodiment of a fuel cell power generation system according to another aspect of the invention, and FIG. 4 and 5 are perspective views illustrating a mobile phone based on an embodiment of a fuel cell power generation system according to another aspect of the invention.

Illustrated in FIGS. 3 to 5 are a fuel cell generation system 200, a hydrogen generation part 210, an anode 212, a cathode 214, a liquid-gas separation membrane 220, a cap 230, a connection terminal 240, a control circuit 245, a housing 250, apertures 260, channels 265, a membrane electrode assembly (MEA) 270, a fuel cartridge 280, a cover 290 and a mobile phone 295.

This embodiment presents a fuel cell generation system 200, in which the efficiency of generating electrical energy can be increased since the efficiency of generating hydrogen at the fuel cartridge 280 increases, and in which the electrical energy can be generated more simply and effectively since replacement of the fuel cartridge 280 is simple.

In this embodiment, the construction and operation of the fuel cartridge 280, which includes the hydrogen generation part 210, anode 212, cathode 214, liquid-gas separation membrane 220, cap 230 and connection terminal 240, are substantially the same as or similar to those of the embodiment described above, and thus will not be described again. The descriptions hereinafter will focus on the control circuit 245, housing 250, apertures 260, membrane electrode assembly (MEA) 270 and cover 290, which form the differences from the previously described embodiment.

The fuel cartridge 280 can be positioned inside the housing 250, which can be sealed by the cover 290 described below. That is, since the inside of the housing 250 is sealed by the cover 290, electrical energy can be efficiently generated without the loss of hydrogen even though hydrogen is generated through the total surfaces of the liquid-gas separation membrane 220 at the fuel cartridge 280.

In addition, the apertures 260 may be formed on the housing 250 such that the membrane electrode assembly 270 is exposed to outside air. Thus, air can be supplied naturally to an air electrode of the membrane electrode assembly 270 without any air ventilation device so that a smaller fuel cell generation system can be implemented.

Also formed on the housing 250 can be the channels 265, which move hydrogen from the fuel cartridge 280 to the membrane electrode assembly 270. Accordingly, the hydrogen generated at the fuel cartridge 280 can be traveled to a fuel electrode through the channels 265 formed on the housing 250.

The membrane electrode assembly 270, which is coupled to the inside of the housing 250, can convert the chemical energy of the hydrogen to produce electrical energy and can be comprised of the fuel electrode and the air electrode and an electrolyte membrane interposed between them. Here, the electrolyte membrane, which is interposed between the fuel electrode and the air electrode, can move hydrogen ions, generated from the oxidation of the fuel electrode, to the air electrode and can be made of high polymers.

In addition, the fuel electrode, which is formed on one side of the electrolyte membrane, can produce hydrogen ions and electrons by the oxidation at a catalytic bed of the fuel electrode to which hydrogen is supplied. On the other hand, the air electrode, which is formed on the other side of the electrolyte membrane, can produce oxygen ions by the reduction at the catalytic bed of the air electrode to which oxygen and the electrons generated from the fuel electrode are supplied. Through the oxidation and reduction, electrical energy can be directly produced from chemical energy, and the reactions at the fuel electrode and the air electrode can be represented by the following Reaction Scheme 1:

[Reaction Scheme 2]

| | |
|---|---|
| Fuel electrode: | H₂ → 2H⁺ + 2e⁻ |
| Air electrode: | O₂ + 4H⁺ + 4e⁻ → 2H₂O |
| Overall Reaction: | 2H₂ + O₂ → 2H₂O |

The cover 290 can be coupled to the housing 250 to seal the interior of the housing. That is, as described above, the loss of hydrogen can be prevented by closing the housing 250, in which the fuel cartridge 280 is accommodated, with the cover 290. In case the hydrogen generation comes to a halt since the reaction of the fuel cartridge 280 is completed, the cover 290 can be opened to remove the fuel cartridge 280, and a new fuel cartridge refilled with an electrolyte solution can be placed inside the housing 250, and then the housing can be sealed with the cover 290, so that electrical energy can be continually produced. Meanwhile, the control circuit 245, which is configured to control electrical conduction of the anode 212 and the cathode 214 by being electrically connected to the connection terminal 240, can be formed on the cover 290. When the cover 290 is closed, the connection terminal 240 and the control circuit 245 can be electrically connected, and electrical conduction of the anode 212 and the cathode 214, which are electrically connected to the connection terminal 240, can be controlled by the control circuit 245 so that the time and quantity of hydrogen generation can be controlled.

The fuel cell generation system 200 in accordance with an embodiment of the present invention can be applied to mobile devices such as a mobile phone 295, and, as illustrated in FIGS. 4 and 5, can be used as a substitute for a conventional battery. The fuel cartridge according to an aspect of the invention can prevent an effect of electrolyte solution flowing backwards when generating hydrogen, and can increase the efficiency of hydrogen generation by minimizing the loss of the electrolyte solution.

According to certain aspects of the invention as set forth above, the fuel cell generation system can thus increase the efficiency of electrical energy generation since the efficiency of hydrogen generation increase, and can generate electrical energy more conveniently and effectively due to the convenience of replacing the fuel cartridge.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention. As such, many embodiments other than those set forth above can be found in the appended claims.

What is claimed is:

1. A fuel cartridge comprising:
a hydrogen generation part configured to generate hydrogen by reacting with an electrolyte solution;
a liquid-gas separation membrane configured to surround the hydrogen generation part, separate the generated hydrogen from the electrolyte solution and discharge the hydrogen to the outside; and
a cap configured to open and close the liquid-gas separation membrane.

2. The fuel cartridge of claim 1, wherein the liquid-gas separation membrane is made of a flexible material.

3. The fuel cartridge of claim 1, wherein the liquid-gas separation membrane is made of a material comprising a hydrophobic substance having multiple air holes formed therein.

4. The fuel cartridge of claim 3, wherein the liquid-gas separation membrane is made of a material comprising poly tetra fluoro ethylene (PTFE).

5. The fuel cartridge of claim 1, wherein the hydrogen generation part comprises:
an anode configured to generate electrons; and
a cathode configured to generate the hydrogen by receiving the electrons from the anode.

6. The fuel cartridge of claim 5, wherein a connection terminal is formed on the cap, the connection terminal configured to electrically connect the anode and the cathode to the outside.

7. A fuel cell power generation system comprising:
a housing;
a membrane electrode assembly (MEA) coupled to the housing and configured to generate electrical energy by converting chemical energy of hydrogen;
a cover coupled to the housing to seal the housing; and
a fuel cartridge positioned inside the housing and configured to supply the hydrogen to the membrane electrode assembly, wherein the fuel cartridge comprises:
a hydrogen generation part configured to generate the hydrogen by reacting with an electrolyte solution;
a liquid-gas separation membrane configured to surround the hydrogen generation part, separate the generated hydrogen from the electrolyte solution and discharge the hydrogen to the outside; and
a cap configured to open and close the liquid-gas separation membrane.

8. The fuel cell power generation system of claim 7, wherein the liquid-gas separation membrane is made of a flexible material.

9. The fuel cell power generation system of claim 7, wherein the liquid-gas separation membrane is made of a material comprising a hydrophobic substance having multiple air holes formed therein.

10. The fuel cell power generation system of claim 9, wherein the liquid-gas separation membrane is made of a material comprising poly tetra fluoro ethylene (PTFE).

11. The fuel cell power generation system of claim 7, wherein the hydrogen generation part comprises:
an anode configured to generate electrons; and
a cathode configured to generate the hydrogen by receiving the electrons from the anode.

12. The fuel cell power generation system of claim 11, wherein a connection terminal is formed on the cap, the connection terminal configured to electrically connect the anode and the cathode to the outside.

13. The fuel cell power generation system of claim 12, wherein a control circuit is formed on the cover, the control circuit configured to control electrical conduction of the anode and the cathode by being electrically connected to the connection terminal.

14. The fuel cell power generation system of claim 7, wherein apertures are formed on the housing such that the membrane electrode assembly is exposed to outside air.

15. The fuel cell power generation system of claim 7, wherein channels are formed on the housing, the channels configured to move the hydrogen from the fuel cartridge to the membrane electrode assembly.
